(19) United States
(12) Patent Application Publication
(10) Pub. No.: US 2008/0097972 A1
(43) Pub. Date: Apr. 24, 2008

(54) System and method for efficiently tracking and dating content in very large dynamic document spaces

(75) Inventor: Raz Gordon, Hadera (IL)

Correspondence Address: Collage Analytics LLC, 1652 48th Street, Brooklyn, NY, 11204, US

(73) Assignee: Collage Analytics LLC,

(21) Appl. No.: 11/924,598

(22) Filed: Oct. 25, 2007

Related U.S. Application Data
(63) Continuation-in-part of application No. 11/379,094, filed on Apr. 18, 2006.
(60) Provisional application No. 60/672,256, filed on Apr. 18, 2005.

(51) Int. Cl. G06F 17/30

(52) U.S. Cl. 707/3; 707/E17.014

(57) ABSTRACT

Systems and methods are provided for tracking the origins and dates of a document or piece of content by finding similar or exact matching documents or pieces of content stored in an index. The index may include current and non-current documents along with associated information for each document. By parsing each document using various schemes, it is possible to correlate similar or matching documents. Using such document correlations, it is possible to determine the origins and earlier dates of a particular document.

### CROSS REFERENCE TO RELATED APPLICATIONS

This application is a continuation-in-part of U.S. patent application Ser. No. 11/379,094, filed on Apr. 18, 2006, which in turn claims priority under 35 §U.S.C. 119(e)(1), to the filing date of U.S. provisional patent application Ser. No. 60/672,256, entitled “System and method for efficiently tracking and dating content in very large dynamic document spaces”, filed on Apr. 18, 2005, the disclosures of which are hereby incorporated herein by reference in their entirety.

### BACKGROUND OF THE INVENTION

The last decade has seen the World Wide Web (“web”) evolving into a vast information resource, comprising billions of web pages and documents that are stored on millions of servers and computers worldwide. The web is accessible to users of personal computers that are connected to the Internet, by utilizing web browsers (“browsers”), such as Microsoft's Internet Explorer®. To access a particular web page, a user points his browser to the web address of the web page, also know as a Uniform Resource Locator (“URL”), which initiates the downloading and viewing of the web page. The user may also click (i.e. select) a hyperlink on the web page which causes the browser to download and display the web page addressed by the hyperlink. The document types that are accessible through the web include conventional web pages written in the Hypertext Markup Language, (“HTML”), as well as other document types, such as Adobe PDF files and Microsoft Word® files (the various documents types are collectively referred to herein as “documents”).

Search engines assist users in locating desired information on the web. A user submits a search query to the search engine, comprising one or more search terms or keywords, and is returned a list of documents responsive to the search query. Search engines are deployed on top of smart indexing technologies, enabling fast and efficient search and retrieval. A search engine generally employs one or more robots or spiders that traverse the web and download each web page they encounter. The robots delve deep into the vastness of the web by opening the many hyperlinks that are included in each web page they find. Documents that are returned in a search results list often number in the thousands or millions. The search engine therefore employs intelligent ranking techniques for ranking and ordering documents in the search results list based on importance. A document's comparative popularity and relevance to the search query influences its relative ranking in the search results list.

A search engine constantly refreshes its index by reloading the documents included in the index. The index will as a result reflect changes in documents or the removal of entire documents and will return to the user only substantially currently available data. In addition newly published documents and documents previously not found by the search engine are also constantly added to the index.

Search engines generally store date information for each document included in the index. Such date information may include: the date the document was first found by the search engine; date information retrieved from the server the document is stored on; the date last indexed by the search engine; and/or the date the document was last modified. Most search engines enable users to search, using advanced search options, which among other features allow the users to limit the search query to documents updated within a given time period, such as the last month, three months or year.

Web pages and other documents are often moved to different locations on a website or from one website to another. Complete web sites may also change their URL, e.g. following changes to the owning company's name. Portions of web pages are sometimes copied or otherwise relocated to other web pages, in which they may be surrounded by entirely different content (e.g. when copying example program code from a web manual to a forum post). The Internet is an uncontrolled and distributed medium and web pages and websites are constantly being updated, relocated, or copied to other websites. As such, a search query narrowed to documents updated within the last 3 months may yield as much as 50% of the total web pages responsive to that search query.

Using currently available search engine technology, tracking the approximate origins and date of a web page or document or one or more portions thereof (“piece of content”) is either impossible or yields poor results. Thus, there remains a need for a search engine with functionality that includes a means for determining the origins and a date of a document, such as a web page, or piece of content regardless of when the document or piece of content was first posted to a website or accessed by a search engine.

### SUMMARY OF THE INVENTION

System and methods consistent with the principles of the present invention may track the origins and dates of a document or piece of content by finding similar or exact matching documents or pieces of content stored in an index. This ability to track the origins and earlier dates for the documents in the index further facilitates searching for documents based on a specific date range provided by a searcher.

According to one aspect consistent with principles of the present invention, a system and method is provided for preprocessing a document to remove information considered redundant for the purpose of finding matching documents and pieces of content.

According to another aspect consistent with principles of the present invention, a system and method is provided for maintaining a search engine index. The index preferably includes information, of both, documents that are accessible on the web at the time of a search, based on the URL's associated with those documents, as well as older documents, that were removed from the web, and are therefore not accessible by the URL's associated with those documents. Further, each URL stored in the index may be associated with multiple different documents and/or multiple versions of such documents as the content document available when accessing the URL changes over time.

According to yet another aspect consistent with principles of the present invention, a system and method is provided for parsing a document to determine uniquely identifiable content elements within the document.

According to yet another aspect consistent with principles of the present invention, a system and method is provided for searching an index for one or more documents or pieces of content that match a given document or piece of content based on a similarity threshold.

According to yet another aspect consistent with principles of the present invention, a system and method is provided for determining whether a given document or piece of content matches one or more documents or pieces of content based on a similarity threshold, and attributing a date to the given document or piece of content based on one or more dates attributed to the one or more matching documents or pieces of content.

According to yet another aspect consistent with principles of the present invention, a system and method is provided for filtering and/or ranking documents, especially documents returned in response to a search engine query, based at least in part on the dates attributed to those documents in accordance with principles specified herein.

Additional novel features and aspects are set forth in part in the description that follows, and are in part inherent and/or obvious from the description. The novel techniques described herein may be implemented using various well-known software and hardware technologies.

### DETAILED DESCRIPTION OF THE PREFERRED EMBODIMENTS OF THE PRESENT INVENTION

System and methods consistent with principles described herein provide users with greater search flexibility, and effective means for determining approximate original dates associated with specific web content. The following description of the preferred embodiments of the present invention specifies data structures and algorithms that can be used to implement a stand-alone dating and tracking search engine, or in order to add these capabilities to existing Internet search engines.

The present invention is not limited to the Internet (although the dating and tracking problem is far worse on the Internet due to the enormous information stored on its servers). The solutions described herein can deal within any document space, regardless of whether this is the web or another type of distributed or non-distributed document storage system.

Section 1: Introduction

Search engines retrieve information from dynamic document spaces like the web using robots/spiders—software agents that continuously scan the document space, retrieve documents, process content found in the documents and update the search engine's indices in order to allow fast retrieval of documents matching the user-specified search criteria.

The search engine's index is built to serve specific types of search queries. The most widespread type of query is a set of keywords for which the search engine tries to find and rank the matching documents.

Described herein are specific data structures and algorithms for building indices, for quick retrieval of date information, and for tracking information of documents and pieces of content in a dynamic document space. The content processing is preferably fast (of O(n) complexity, which is the theoretically-minimal complexity) and generates space-efficient indices. The data structures and algorithms are preferably configurable by the search engine to optimize the trade off between the space required for the index and the level of functionality supported by the search engine (quality of search results).

A novel feature of the indexing techniques of the preferred embodiments is as follows. Ordinary document indexing techniques view the document as the basic building-block of the document space. As a result, they fail to detect much of the document dynamics, which results from intra-document evolution. As described herein a different approach is suggested. Instead of viewing the document as a single entity, the document is viewed as a patchwork of pieces of content. The pieces of content of each document which are uniquely identified by the search engine are referred to herein as “Collage Elements”. The document itself containing the Collage Elements is referred to herein as a “Collage”. A search engine employing the techniques of the preferred embodiments may track the evolution of each Collage's Collage Elements and their parent document association. The document is merely the container of the Collage, and the object that links the Collage Element to the document address space.

Many retrieval functions may be implemented by the search engines on top of the indices described herein. The following generic retrieval functionality is more fully described herein:
1. The ability to define a similarity threshold, which helps the search engine decide whether two non-identical documents or pieces of content are essentially the same (i.e. similar) or not.
2. Given a document or a piece of content, find the earliest date of a similar document or piece of content (regardless of the address of the similar document/piece of content).
3. Given a document or a piece of content, get all addresses at which the document or the piece of content exists or existed in the past, including the earliest and latest date of the document/piece of content at each address, and dates on which changes to the document/piece of content were made.
   Section 2: Preprocessing the Content

Preprocessing is optional but preferable, and is used to improve the search results by reducing “document noise”. The search engine may perform the preprocessing at the time of the indexing of the documents, or the preprocessing may be performed at a later time. The preprocessing may optionally also occur in real time while a search query is being processed by the search engine.

Any preprocessing that reduces “document noise” may be used with the present implementation. Preferably, at least one preprocessor of each of the classes mentioned below is to be used. Since it is preferable to maintain space-efficient indices, it is therefore recommended to perform the following preprocessing of the content, in order to remove “redundant” information and/or convert the content to a congruous compact representation.

Section 2.1: Static Preprocessing

Virtually all formatted (and most unformatted) documents contain information which is redundant for the purposes of deciding whether two pieces of content are essentially the same or not. Examples for such information are: invisible portions of HTML tags, images, input fields, meta information, scripts, dynamic content, comments, hyperlinks, upper/lower case settings, font type, style and size, redundant white spaces, etc.

The best way to witness the problem is to load an HTML page, which was created using some authoring tool, into a different authoring tool, and save it to a new file without making any modifications. Usually, the new file will be different than the original file, although the documents are identical when viewed using a web browser.

A simple example for static preprocessing is the conversion of all uppercase text to lowercase, in order to allow case-insensitive searches.

The search engine may implement preprocessing in accordance to the methods it uses to determine the Collages Elements, such as one of the methods entitled “Collage Schemes” that are described further on. For example, with the Structural/Hierarchical Collage Scheme some information that may otherwise be considered “redundant” should be preserved. For example, the Structural/Hierarchical Scheme uses the structure information of the document for identifying the different sections of the content. The preprocessor should be aware of such cases and leave the relevant information intact. As a result, preprocessing of the same content may yield different results for different Collage Schemes.

The specific classification of “redundant” information is subjective and may have tradeoffs. For example, leaving the bold/italics formatting property may lead to misses in identifying the same text in different styles (in case the bold/italics property is different). On the other hand, the search engine may decide that a long bold-formatted section of text should really be considered different compared to the same text with no bold formatting. The search engine may also employ techniques for using an optimal implementation that would overcome the aforementioned tradeoff.

Section 2.2: Dynamic Preprocessing

Formatting languages frequently allow identical content to be specified in several ways. In order to improve the search engine's ability to properly match the content's essence, “dynamic” preprocessing may be used. This type of preprocessing resolves ambiguities by translating the various possible representations of a piece of content into some predetermined “normal” representation.

For example, HTML provides the following tags: <thead>, <tfoot> and <tbody>, for declaring the table header, footer and body respectively. The order in which these elements appear within the <table> element does not make a difference—the header will always appear on top, then the body and finally the footer. Therefore, there are multiple possible representations for the same table in HTML. A dynamic preprocessor should choose a single “normal” table representation, e.g. the header first, then the body and finally the footer and convert any HTML table definition containing two or more of these tags to the “normal” representation.

Section 2.3: Trans-Format Preprocessing

The same content may be specified using different formatting languages. For example, the content of a Rich Text Format document may be identical to the content of an HTML document. Yet, the raw files will be different due to the differences between the formatting languages. Without trans-format preprocessing the search may be less efficient in cross-format searches.

Trans-format preprocessing bridges the differences between the different formatting standards by translating any supported format to a “normal” format. For example, it is possible for a trans-format preprocessor to support Microsoft Word™, WordPerfect™, Rich-Text Format and HTML documents by translating documents of the first three formats to HTML. In this case, HTML is the “normal” format chosen.

Section 3: Generating a Collage

One important concept is to view the document as a set of pieces of content, or, more precisely, as a set of processed pieces of content (“Collage Elements”). There may be different views, and therefore different schemes of Collages for the same document. The information derived from the different Collage Schemes fulfill (alone or together) different search engine functionality requirements.

Collages are generated to provide for efficient indexing and/or searching of documents and pieces of content. A Collage contains, in addition to optional document and Collage attributes one or more “Collage Scheme Information” objects. The preferred embodiments may implement at least one of the three suggested types of Collage Schemes for processing documents. Each Collage Scheme generates unique Collage Scheme Information that is attributable to the document and is contained in the Collage. The Collage Scheme Information in addition to the scheme's attributes contains Collage Elements and/or Sub-Collages.

The following sections provide a “bottom up” description of the data structures of Collages, Collage Scheme Information, Collage Elements and the underlying fundamental algorithms.

Section 3.1: Collage Elements

A Collage Element is a data structure used to represent a portion of content. Collage Elements are used in order to find identical matches for such portions of content.

Collage Elements are generated by the various Collage Schemes while processing pieces of content or complete documents. Collage Elements are designed to consume very small space, allowing space-efficient indices to be created.

The Collage Element serves as the “anchor” for fast lookups and query processing of the search algorithms described below.

A Collage Element includes:

I. Content Summary: this value is the Collage Element key for indexing and retrieval. It may be indexed using virtually any indexing method (hash tables, B-Trees, etc.).

Any deterministic function CS that maps the content space C to some summary space S, may be used for calculating the Content Summary for a given document or piece of content. The determinism requirement means that CS yields the same result for the same content in all runs.

Preferably, Content Summary results are uniformly-distributed in S—this decreases the probability of false-positive errors to the minimum.

Preferably, the choice of S takes into account the following considerations:
a) The expected size of the content space.
b) S should be preferably small so that members of S can be represented by a small number of bits.
c) S shouldn't be too small since the probability of false-positive errors increases as the size of the summary space decreases.

Hash functions may be used for calculating the Content Summary value. See the analysis section below for value size and method selection of the Content Summary function.

Another possible Content Summary function is dictionary-based: the piece of content is archived and gets a unique ID. The Content Summary function maps all the duplicates of a piece of content to its unique ID.

Preferably, to improve performance of search methods that use the sliding window method (see below), the Content Summary value should be calculated using a Content Summary function that can be recalculated in constant time as the sliding window moves (i.e. recalculation complexity may be a function of the step size but should be independent of the sliding window size).

II. Parent Collage Scheme Link: this link, which may be technically represented and implemented in various ways, provides access to the Collage Element's parent Collage Scheme Information object. It may optionally also provide (directly or indirectly):
a. The relative position of the Collage Element within the Collage Scheme Information. For example, identifying it as the cell at row 3, column 5 of the table at the end of the second paragraph of the page.
b. Access to the other Collage Elements in the scheme.

### EXAMPLE

This example shows a possible parent Collage Scheme Information Link representation for Collage Elements of the Structural/Hierarchical Collage Scheme (see below): A string of values of the form ‘<parent Collage Scheme Information Unique ID> .<Level 0 Element ordinal number> ...<Level K element ordinal number>’ for a Collage Element that is at the K^{th} level of the hierarchy. The ordinal number is a unique, serial number of the element that distinguishes it from the other elements on the same level:
a. The Collage Scheme Information Unique ID provides access to the Collage Element's parent Collage Scheme Information.
b. The string defines the relative position of the Collage Element within the Collage Scheme.
c. Indexing these Parent Collage Scheme Information Link strings allows simple retrieval of other Collage Elements in the scheme: all elements, neighboring elements, elements in other levels of the hierarchy on the same or other branches, etc.

For typical HTML documents this representation should be compact, since (except for the Collage Scheme Information ID) the bit consumption of the other fields is low, and there are a few levels of document hierarchy in a typical HTML.

Optionally, to reduce the risk of false-positive matches with Content Summary values, the Collage Element may contain:

III. Content attributes: comparing simple attributes, like the content size in bytes, can dramatically reduce the risk of false-positive matches. The content size may be required for calculating the Match Coverage (see below), which is required for implementing the Similarity Threshold feature (see below).

IV. Random mask hash: to avoid false-positives resulting from some systematic problem of the selected Content Summary function, it is possible to add a double-check hash code to the Collage Element. In order to help achieving the uniform distribution of the hash it is possible to mask the content with pseudo-random data (e.g. using a XOR function) and calculate the hash of the resulting data. It is only needed to save the seed of the pseudo-random series and the resulting hash value.

Example Collage Element size:

1. Content summary: 128 bit.

2. Parent Collage Scheme Information Link: 64 bit Collage Scheme ID.

3. Content size: 32 bits.
The total size is 224 bits=28 bytes. This size excludes index data structure sizes, which depend on the chosen indexing method.
   Section 3.1.1: Content Summary Analysis

Careful selection of the Content Summary function is important for good implementation of Collage, since it affects the efficiency of the search, the complexity of the calculation and the level of false-positive errors.

Section 3.1.2: Determining Summary Value Size

Summary value size (in bits) should be determined by the size of the Collage Element's space. Assuming a uniform distribution Content Summary function, the probability of a false-positive error is: (the total number of Collage Elements generated for the document space)/(the size of the Content Summary space).

Combining this with the optional Content Attributes and/or Random Mask Hash may reduce this probability even further.

For example, current Internet search engines index a document space of less than 10 billion documents. Assuming an average less or equal to 1000 Collage Elements per document (including historic versions), there will be a total of less than 2⁴⁴ Collage Elements. A 128-bits hash function with O(n) complexity has a practically-zero probability (less than 2⁻⁸⁴, or 10⁻²⁵) of producing a false-positive error.

Section 3.2: Collage Schemes

A Collage Scheme is a method of content processing, which compiles a document or a piece of content into Collage Scheme Information. Collage Scheme Information may contain Collage Elements, Sub-Collages, as well as other scheme- and collage-related information.

More than a single Collage Scheme may be used to process a document or a piece of content.

The scope of content processed by the different Collage Schemes within the document may be overlapping and/or nested. It is possible to:
1. Process the same piece of content, or the entire document, using different Collage Schemes.
2. Process different pieces of content or different sections of the document using different Collage Schemes.
3. Use a Collage Scheme within a Sub-Collage of another Collage Scheme: Collage Scheme A may use Collage Scheme B to process a portion of the piece of content/document that it is processing. The Collage Scheme information produced by Collage Scheme B will be linked to a Sub-Collage of the Collage Scheme information produced by Collage Scheme A.

Any Collage Scheme defines a processing method. Unless otherwise specified, the scheme may be used for any level/scope of the document. For example, it may be used for processing the entire document, but also for processing a specific table element, or a specific paragraph.

As used herein the general term “content” refers to any piece of content or the entire document, which is processed by the various Collage Schemes.

Collage Scheme Information is the principal data generated by any Collage Scheme. Collage Scheme Information may be technically represented in various ways and may be stored as a separate data structure or incorporated into other data structures, e.g. Collage information data structures. For simplicity purposes this description views it as a separate data structure.

The following information may be generated by a Collage Scheme:
1. Collage Scheme Attributes: these include any relevant information about the Collage Scheme, e.g. the Collage Scheme's type.
2. Collage Elements and Sub-Collages: these are the Collage Elements and Sub-Collage information (or links to such elements/sub-collage information) generated by the Collage Scheme.
3. Parent Collage Information Links: this allows accessing the parent Collage Scheme Information object.
   Section 3.2.1: the Structural/Hierarchical Collage Scheme

The Structural/Hierarchical (SH) Collage Scheme is used to create Collage information for the content based on its document structure. The motivation behind this scheme is to break down the content into meaningful pieces based on its formatted structure.

The Collage Elements created by the SH Collage Scheme allow the various elements of the document to be rapidly looked up, even when moved within the document or when they reappear in a different document, and regardless of their containing document's address.

Virtually any document formatting language has various constructs to define the document structure. For example, the following HTML tags/elements that have structural meaning:

<body>—the body of the HTML document is included in this element.

<h1>. <h6>—header tags.

<p>—paragraph element.

<br>—line break.

<hr>—horizontal rule.

Frame tags.

List tags.

Table tags.

<div> and <span>—define sections in the document

The SH Collage Scheme is a recursive scheme that uses such document structure constructs to identify the pieces and sub-pieces of contents. The recursive process is simple. Given a document element, a new Collage Element is generated to represent the document element, and its various parameters are populated (see the Simple Collage Scheme in section 3.2.3 below). In addition to, or instead of generating the single Collage Element, it is possible to process the document element using one or more different Collage Schemes (e.g. the Flat Collage Scheme) to create Sub-Collage information for the document element. It is even possible to dynamically decide how to process the document element, based on the document and document element properties (e.g. use the Flat Collage Scheme only for elements whose size exceeds some threshold). The document element may also be parsed to detect structural sub-elements using the SH Scheme. This parsing may be done in advance (e.g. once for the entire document) in order to speed up the process. Sub-elements are recursively processed.

The resulting Collage Elements may be viewed as forming a tree structure (isomorphic to the recursion tree). As explained above, information may be stored in the Collage Element to facilitate access to its parent Collage Scheme Information and the other Collage Elements of the scheme, as well as for determining the tree path from the root to the Collage Element.

Preferably, the search engine should limit the depth of the recursion and/or avoid recursion into elements based on various criteria, e.g. small-sized elements. Preferably the search engine may process different document elements using different methods, based on various criteria, e.g. short elements may be processed by generating single Collage Elements while long elements may be processed using the Flat Collage Scheme.

Section 3.2.2: The Flat Collage Scheme

Large content is likely to experience slight changes over time. Such changes include relatively-small insertions, deletions, and replacements of portions of the content.

The Flat Collage Scheme enables the creation of indices that allow, given some content, to quickly look up similar pieces of content.

The Flat Collage Scheme uses fundamentally-different procedures for indexing and for the search and match methods of section 5 (i.e. the sliding window mechanism). This is in contrast to the SH Collage Scheme, in which the indexing and search processes are of similar procedures for parsing document structures.

Following is the procedure for generating database information of the Flat Collage Scheme (see below for the search procedure):
1. Collage Scheme Information is generated for the Flat Collage.
2. The piece of content is split into blocks using a deterministic process (e.g. fixed-size blocks).
3. A Collage Element is created for each of the blocks, using one of the Content Summary functions mentioned above.
   Section 3.2.3: The Simple Collage Scheme

This scheme generates a single Collage Element for the entire piece of content or document.

It is useful for short pieces of content, and may be used as a default scheme when other Collage Schemes are not calculated for the content.

Section 3.3: The Collage

Collage information contains Collage-generated data about a document or a piece of content. Preferably the Collage information is a separate data structure for convenience, although it may be represented and implemented in various ways, e.g. the information may be stored with Collage Scheme Information and/or Collage Elements. Moreover, there may be advantages for storing this information elsewhere, e.g. for speeding up retrieval processes.

The Collage information data structure elements fall into the following categories:

1. Processed document attributes.

2. Collage processing results for the document.

For supporting the required dating and tracking functionality, Collage information should contain the following processed document attributes:

I. Date attribute (document-level collage only): the date of the processed document as known at the time of processing. This value is a key for indexing and retrieval. One or more methods may be used for determining a document's date. Moreover, this attribute may comprise of multiple date values, e.g. document creation date, document modification date, date last accessed, date last visited by the search engine, etc.

II. Document address (document-level collage only): the address of the document when processed (i.e. its URL in the context of the web). This value is a key for indexing and retrieval.

III. Collage Schemes: all Collage Scheme Information objects (or links to such objects) used to process the document, optionally with their respective processing scope (in cases of Collage Schemes that were used to process portions of the document).

Creation of a new Collage information object is straight forward:
1. Given a document or a piece of content, create a new Collage information object. For documents, populate the Collage information document attributes with document information.
2. Use one or more Collage Schemes to process the document, and add/link the resulting Collage Scheme Information objects to the Collage information. The decision of which Collage Schemes to use may be either taken arbitrarily or dynamically, based on content properties.
   Section 4.1: Indexing a Document—Storing a New Collage

The result of processing a document is Collage information. The Collage information may be linked to, or contain, one or more Collage Scheme Information objects, each of which is linked to, or contains, Collage Elements and/or Sub-Collages.

The Collage information should be indexed for fast access to the relevant information items. This can technically be done in many ways and the method to choose is implementation-specific, and depends on the actual data structures maintained by the implementation.

Using the preferred abstractions as described herein, indexing may be performed using the following procedure:

A. Search and retrieve existing Collages by the new Collage's URL. This determines if the index already includes one or more Collages that were addressed by the same URL of the Collage currently being indexed. If more than one is found, compare the new Collage to the most recent indexed Collage (based on the date information of the retrieved Collages). If the new Collage and the previous Collage are identical (except for the date), perform either of the following (decision of which to choose is implementation-dependent):
1. Do not store and index the new collage and finish (in case visit dates don't matter and only modification dates should be remembered); OR
2. Update the date of the existing Collage and finish (e.g. for saving the last visit date); OR
3. Add the new date to the existing Collage (as a new visit date of the search engine) and finish; OR
4. Delete the existing Collage from the indices and continue to step B.

B. If the new Collage and the previous Collage addressed to the same URL are not identical (or if option 4 above is selected) then add references for the new Collage structure to the indices. All stored Collage objects should be indexed to allow fast retrieval using object references. In addition, it is recommended to index the following data items for fast retrieval of their containing objects:
1. Document attributes:
   i. Document address.
   ii. Document date information.
2. Collage Elements:
   iii. Content Summary.

The search engine would essentially be storing and indexing Collage information of various versions of a single document as such document evolves over time (although the different versions of the document may be associated with a single URL address, only the most current version of the document would be accessible to a user browsing the web). Further, the search engine would continue to store and index Collage information for a given document, regardless of whether the URL for the document is still active. This is advantageous, in the sense, that it provides capabilities for determining whether a particular piece of content had previously existed on the web (whereby an earlier date is associated), regardless of whether the previous indexed piece of content is currently accessible on the web using its historic URL.

Section 4.2: Purging Collages from the Index

Collage and Collage Scheme Information, as well as Collage Elements, are preferably designed to be of tiny size in order to allow storing a very large number of them and therefore provide virtually-unlimited dating and tracking capabilities.

Despite these small sizes, Collage items should preferably not be accumulated forever. Therefore, at some stage it may be required to purge items from the index.

Clearly, every such purge loses information. Therefore, the purging process preferably prioritizes Collage Elements, Collage Scheme Information objects and Collage information objects by their importance rather than creation dates. Deciding the importance evaluation method is implementation-specific.

The purging process itself is simple—just delete the least-important Collage information object and all its Collage Scheme Information objects, Collage Elements and Sub-Collages from the database.

For example, if finding the original date is the main use of the implementation, we preferably don't purge the earliest-date Collage of a document address.

Section 5: Collage Search and Match Methods

This section specifies the basic content matching procedures. Typically the procedures described in this section are used for determining similarities among documents and pieces of content that are included in the index. For example the search engine may determine that a document that was first found today at a new URL, in fact includes some elements that were first found in a historical document (that may currently no longer be accessible on the web). The historical document may have also been addressed by a different URL. If the matching elements are a substantial portion of the new document, then the search engine may attribute the date of the historical document to the new document. The search and match calculations are preferably performed for each document in the index, and the search engine as a result, generates original date information for each document in the index. This generated data may be stored in the index database along with other document information. Alternatively, the search engine may perform the search and match calculation in real time for documents that are returned in response to a search query.

Section 5.1: Simple Search

This search technique finds single Collage Elements matches only:
1. Optionally preprocess the content (in the event such document or content was not previously pre-processed and indexed by the search engine).
2. Calculate a single Collage Element for the entire content.
3. Retrieve all matching Collage Elements (with equal Content Summary, and optionally equal content length and other matching attributes).
   Section 5.2: Structure-Based Search

Structure-Based search performs a document scan operation identical to the one performed by the SH Collage Scheme (see above). At each level of the document structure hierarchy it searches for all possibilities of Collage Elements that could have been generated by the SH Collage Scheme:
1. Optionally preprocess the given document or piece of content (in the event such document or content was not previously pre-processed and indexed by the search engine).
2. Split the content into its top-level structural elements (as described above in section 3.2.1).
3. If there are less than 2 such structural elements: return with an empty result set (no structural partitioning of the document at this level).
4. For each structural element (“Piece of Content”):
   a. Retrieve matching Collage Elements of the Piece of Content using the Simple Search (see section 5.1 above), and add to the result set.
   b. Retrieve matching Collage Elements of the Piece of Content using Sliding Window Search (see section 5.3 below), and add to the result set.
   c. Recursively perform Structure-based Search on the Piece of Content, and add the returned results to the result set.
5. Return the result set.
   Section 5.3: Sliding Window Search

Sliding window search is used to scan a long document or piece of content (“the content”) for matching subsections.

A fixed-size window is moved along the content. The window size is determined by the same method which determines the block size for the Flat Collage Scheme.

For each of the possible window position the Content Summary is calculated for the section of content within the window boundaries and matching Collage Elements which were generated by the Flat Collage Scheme are retrieved.

Section 5.4: Match Coverage Calculation

Some search methods support similarity searches. Match Coverage provides means for quantifying the degree of similarity between a particular document or piece of content and other content in the index.

Match Coverage expresses the similarity between a particular content (i.e. the content for which a search is performed in the index in order to find matches; referred to herein as the “searched content”) and other content in the index. Each piece of content is represented by a “Root Object”, such as an indexed Collage object (Collage information object, Collage Scheme Information object or Collage Element). The content for which the Match Coverage is calculated is the content spanned by the Root Object's sub-tree of Collage objects.

For calculating Match Coverage, a set of matching Collage Elements (such elements whose content exists both in the searched content and in the indexed content) should be found by the search function. The Match Coverage is performed for the searched content against a set of matching Collage Elements included in the index that are associated with a single Collage. In other words, the Match Coverage evaluates the similarity or dissimilarity of a piece of content/document against another piece of content/document.

The Match Coverage may be calculated in any reasonable way that provides high scores for similar content.

For example, the Match Coverage may be calculated in the following way:
1. Let the Match Size be the sum of sizes of matching elements contained in the indexed content.
2. Let the Union Set be the union of the searched content and the indexed content. The size of the Union Set is the size of the searched content+the size of the indexed content—the Match Size (which is the overlapping subset of both sets).
3. The Match Coverage is the Match Size divided by the Union Set size.
   Section 5.5: Best Parent Match Coverage

Each of the different search methods (see sections 5.1-5.3 above) results in a collection of matching Collage Elements—the pieces of content that exist both in the searched content and in one or more indexed documents.

The Best Parent Match Coverage of a document is defined as the highest Match Coverage that any of its contiguous sections has.

The Best Parent Match Coverage algorithm finds the best-matching contiguous section which contains a specific matching Collage Element (the “Anchor Element”). Therefore, it may be executed multiple times, for all matching Collage Elements, in order to find the Match Coverage of all documents which contain matching Collage Elements.

The Best Parent Match Coverage algorithm uses the Collage tree generated by the methods described in section 3 above in order to “zoom out” from a given Anchor Element and calculate the Match Coverage for each of its parent tree elements, all the way up to the Collage tree root. By going up the Collage tree, the size of the content being evaluated against the “searched content” increases. This increase in size may either affect an increase or decrease in the Match Coverage value. Therefore it is object to recalculate the Match Coverage for each parent (i.e. tree level or node), and the best fit (i.e. the parent tree object for which the Match Coverage value is the highest) is chosen.

The Best Parent Match Coverage algorithm:

Given a collection of matching Collage Elements and an Anchor Element, loop through the Collage tree path between the Anchor Element and its parent document-level Collage. For each Collage object on the path calculate the Match Coverage, using the path object as the Root Object. Return the highest calculated Match Coverage.

Section 6: Functionality Based on Collage Search and Match Methods

The following section demonstrates how to use the basic search and match methods described above for providing useful functionality.

Section 6.1: Retrieving the Original Date of a Document or a Piece of Content

The following section describes how to retrieve the earliest date for a given piece of content.
1. We hereby refer to the document or piece of content as the “Content”.
2. Retrieve Matching Collage Elements: Collage Elements that match Collage Elements of the Content or pieces of it using all Collage search and match methods (see section 5 above).
3. For each Matching Collage Element:
   a. If the Collage Element's Best Parent Match Coverage (see section 5.5 above) exceeds a given similarity threshold:
      i. Retrieve the Collage Element's parent document-level Collage.
      ii. Retrieve the document attributes from the document-level Collage (document date and address).
4. Return the document attributes having the earliest document date.

The method for attributing a date to the Content may be based entirely or in part on one or more dates associated with the matching Collages. For example, the attributed date may be a weighted or average date associated with the matching Collages. Various alternative algorithms can be employed for utilizing the retrieved date attributes of the matching Collages, in attributing a date to the Content.

As previously noted the procedure for determining a date for a document or content, may be performed for each document in the index, and such date information may be stored in the index database along with other document information.

Section 6.2: Tracking a Document or a Piece of Content

This tracks the history of a document or a piece of content. The result set includes dates and addresses at which the document or piece of content (or similar documents or pieces of content) were present.
1. We hereby refer to the document or piece of content as “the Content”.
2. Retrieve Matching Collage Elements: Collage Elements that match Collage Elements of the Content using all Collage search and match methods (see section 5 above).
3. For each Matching Collage Element:
   a. If the Collage Element's Best Parent Match Coverage (see above) exceeds a given similarity threshold:
      i. Retrieve the Collage Element's parent document-level Collage.
      ii. Retrieve the document attributes from the document-level Collage (document date and address) and add to the result set.
4. Remove duplicate document attributes from the result set.
5. Return the result set.
   Section 6.3: Filtering a Set of Documents Using their Original Date

When a user submits a search query to search engine, the search engine returns to the user a list of documents responsive to the search query (search results list). The number of documents responsive to the search query may be numerous, and the various dates attributed to the documents may span over many years. With the previously described method, (see section 6.1 above) for attributing an earlier date to a given document, a search engine may add a new functionality for filtering documents with dates that are within a specified date range. Unlike existing search engines that attribute dates to documents based on the date the document was first retrieved or last updated, the search engine according to the present disclosure, is more effective for attributing dates to documents, and as such, is more reliable for filtering documents according to the approximate dates the documents were first authored.

When a user submits a search query to a search engine, the search query may also include a date filtering parameter. The search engine first locates all the documents that are responsive to the keyword(s) and/or search terms of the search query. Thereafter, the search engine identifies the “earlier” dates attributed to each document it locates, using the technique described above in section 6.1. The “earlier” date of each document may haven been previously preprocessed, determined and indexed in association with the Collage information of the document, or alternatively, the dating of each of the documents located by the search engine, can be performed in real-time, in response to the search query.

Thereafter, the search engine filters the search results list to only those documents that were attributed dates within the date range specified in the search query. The resulting search results list can then be transmitted to the user and displayed at the user's browser in accordance to the dates attributed to each document, in either ascending or descending order. Alternatively, the search engine may use other ranking algorithms for ordering the filtered search results list.

Section 6.4: Finding Similarities Based on Pieces of Content that Contain Search Terms

This method is meant to serve as a post-processor of any search engine results list. First, the search engine retrieves the documents matching the search query. Given a matching document:
1. Let the Searched Subdocument be the set of pieces of content that contain matching search terms (e.g. pieces of content that contain words found in the search query).
2. Use the content tracking method (Section 6.2 above) to retrieve documents or pieces of content that are similar to the Searched Subdocument.
   Section 6.5: Finding the Most Similar Documents or Pieces of Content

This works similarly to content tracking, but instead of returning references to all content with Match Coverage that exceeds a similarity threshold, only a single reference the content with the highest Match Coverage (the most similar content) is returned.

Alternatively, it is possible to rank all matching content items based on their Match Coverage values, and return the items in such order.

Section 6.6: Enhancing Document Browsers

The above functionality may be integrated into document browsers (either by the software vendor or through a plug-in) in the following way.

When the document browser loads a document, is performs one or more of the analyses specified in this disclosure to identify its different pieces and sub-pieces of content. All or some of these pieces may be (statically or dynamically) marked (e.g. with a visible bounding rectangle that appears around the piece of content when the mouse is moved over it). The browser can be enhanced to display date information for the selected/highlighted piece of content. The browser can be enhanced to run other functions for a selected piece of content (e.g. through a pop-up menu that appears when right-clicking the piece of content), such as displaying a list of similar documents with matching pieces of content, etc.

Section 7: Miscellaneous

Systems and methods contemplated by the present disclosure are implemented by computer systems in a computer network environment. The network may include multiple clients connected to multiple servers via a network. The networks may include a local area network (LAN), a wide area network (WAN), a telephone network, such as the Public Switched Telephone Network (PSTN), an intranet, the Internet, a memory device, another type of network, or a combination of networks. The network connects multiple resources and computers, including clients, servers and workstations. In some instances, a client may perform the functions of a server and a server may perform the functions of a client.

A client may be defined as a device, such as a personal computer, laptop, wireless telephone, a personal digital assistant, or other types of computation or communication devices, a thread or process running on one of these devices, and/or an object executable by one of these device. Servers may include server entities that gather, process, search, and/or maintain documents in a manner consistent with the principles of the invention. Clients and servers may connect to the network via wired, wireless, and/or optical connections.

In implementations consistent with the principles of the invention, servers may include a search engine usable by clients. The servers may crawl a corpus of documents (e.g., web pages), index the documents, and store information associated with the documents in a repository of crawled documents. The servers may store or maintain documents that may be crawled by the servers. One or more of the servers may perform one or more of the functions of another one or more of the servers. For example, it may be possible that two or more servers are implemented as a single server. It may also be possible for a single server to be implemented as two or more separate (and possibly distributed) devices.

Each client/server entity within the network may include a bus, a processor, a main memory, a read only memory (ROM), a storage device, one or more input devices, one or more output devices, and a communication interface. The bus may include one or more conductors that permit communication among the components of the client/server entity. The processor may include one or more conventional processors or microprocessors that interpret and execute instructions. The main memory may include a random access memory (RAM) or another type of dynamic storage device that stores information and instructions for execution by processor. The ROM may include a conventional ROM device or another type of static storage device that stores static information and instructions for use by processor. The storage device may include a magnetic and/or optical recording medium and its corresponding drive.

The input device(s) may include one or more conventional mechanisms that permit an operator to input information to the client/server entity, such as a keyboard, a mouse, a pen, voice recognition and/or biometric mechanisms, etc. The Output device(s) may include one or more conventional mechanisms that output information to the operator, including a display, a printer, a speaker, etc. The communication interface may include any transceiver-like mechanism that enables the client/server entity to communicate with other devices and/or systems. For example, the communication interface may include mechanisms for communicating with another device or system via a network.

The client/server entity, consistent with the principles of the invention, may perform searching-related operations. The client/server entity may perform these operations in response to processor executing software instructions contained in a computer-readable medium. A computer-readable medium may be defined as one or more physical or logical memory devices and/or carrier waves.

The software instructions may be read into the memory from another computer-readable medium, such as the data storage device, or from another device via the communication interface. The software instructions contained in the memory may cause the processor to perform processes. Alternatively, hardwired circuitry may be used in place of or in combination with software instructions to implement processes consistent with the principles of the invention.

Implementations contemplated by the system and methods described herein are not limited to any specific combination of hardware circuitry and software. Many different forms of software, firmware, and hardware for the implementations described. The actual software code or specialized control hardware used to implement aspects consistent with the principles of the invention is not limiting of the present invention. Thus, the operation and behavior of the aspects were described without reference to the specific software code—it being understood that one of ordinary skill in the art would be able to design software and control hardware to implement the aspects based on the description herein.

Appended to this specification are one or more claims, which may include both independent claims and dependent claims. Each dependent claim makes reference to an independent claim, and should be construed to incorporate by reference all the limitations of the claim to which it refers. Further, each dependent claim of the present application should be construed and attributed meaning as having at least one additional limitation or element not present in the claim to which it refers. In other words, the claim to which each dependent claim refers is to be construed and attributed meaning as being broader than such dependent claim.

The present invention has been described in its preferred embodiments and the various novelty aspects of the present invention may be readily appreciated. Various modifications to the preferred embodiments are envisioned, which may include one or more of the novelty aspects described herein, without departing from the spirit and scope of the invention.

Section 8: Pseudo-Code

The following Pseudo-Code illustrates algorithms and data structures that are substantially similar to those described above.

PSEUDO CODE

// -------- constants -----------------

| const int | FlatSchemeBlockSize; | |
|---|---|---|
| const int | MaxSHLevel; | // (optional) max document hierarchy |

// level to recurse into with the SH

scheme
// -------- input structures -----------
class DocumentAttributes {

| | |
|---|---|
| Date | DocumentDate; |
| Address | DocumentAddress; |

}
class Document {

| | |
|---|---|
| DocumentAttributes | Attributes; |
| Content | DocumentContent; |

}
class Content {

| Symbol[ ] | Data; | |
|---|---|---|
| property int | Length; | // return length of ContentData, |

// in symbols (e.g. chars)

Content
GetSubContentByIndexAndLength(int ZeroBasedIndex, int maxLength){

Content subContent;
subContent.Data = Copy Min(maxLength, Length − ZeroBasedIndex)

symbols from Data starting at ZeroBasedIndex;

return subContent;

}

}
// -------- data structures ------------
class CollageObject {

| | |
|---|---|
| CollageObject | Parent = null; |

}
class ContentCollage : CollageObject {

| | | |
|---|---|---|
| CollageScheme[ ] | ContentSchemes; | // the different “views” |

// of the document

}
class DocumentCollage {

| | | |
|---|---|---|
| [indexed] Date | DocumentDate; | // indexed for quick sorting |
| [indexed] Address | DocumentAddress; | // e.g. the document URL when |

// implemented for the
// Internet space

| | |
|---|---|
| ContentCollage | Collage; |

}
class CollageElement : CollageObject {

| [indexed] ContentSummaryValue ContentSummary; | | |
|---|---|---|
| int | ContentLength; | // for calculating the Match Coverage |

}
class CollageScheme : CollageObject {

// base class for all Collage Schemes

}
class CollageSimpleScheme : CollageScheme {

| | |
|---|---|
| CollageElement | Element; |

}
class CollageFlatScheme : CollageScheme {

| | |
|---|---|
| CollageElement[ ] | BlockElements; |

}
class CollageSHScheme : CollageScheme {

| | |
|---|---|
| ContentCollage[ ] | SectionCollages; |

}
// --------- Content Summary Functions -------------
ContentSummaryValue SimpleSchemeSummary(Content c){

return ContentSummaryValue of c.ContentData suitable for simple

schemes (e.g. hash code)

}
ContentSummaryValue SHSchemeSummary(Content c){

returns ContentSummaryValue of c.ContentData suitable for SH

schemes (e.g. hash code)

}
ContentSummaryValue FlatSchemeSummary(Content c){

returns ContentSummaryValue of c.ContentData suitable for flat

schemes and sliding window search

}
// --------- Preprocessors -------------
Content StaticPreprocessor(Content c, bool DontDeleteDocumentStructure) {

“Normalize” text case of c, e.g. turn all text into lower-case
Remove all “redundant” sections of content, based on the document's
formatting language and the DontDeleteDocumentStructure flag, such as:

* invisible portions of tags
* images
* input fields and controls
* Meta information
* scripts
* dynamic content
* comments
* hyperlinks
* upper/lower case settings
* font type, style and size
* redundant whitespaces

return modified c

}
Content DynamicPreprocessor(Content c){

“Normalize” sections of content that may appear in the document in
multiple ways, e.g. order of HTML-related table tags
return modified c

}
Content TransFormatPreprocessor(Content c){

if(DocumentType(c) is StandardDocumentType)

return c;

Content r = Convert document type of c into StandardDocumentType
return r

}
Content PreprocessContent(Content c, bool DontDeleteDocumentStructure){

return StaticPreprocessor(DynamicPreprocessor(

TransFormatPreprocessor(c)) , DontDeleteDocumentStructure)

}
// ------------ Collage Scheme Generators -----------
CollageSimpleScheme GenerateSimpleScheme(Content c){

if(c is not preprocessed)

c = PreprocessContent(c, false);

CollageSimpleScheme r;
r.Element = new CollageElement(

ContentSummary = SimpleSchemeSummary(c),
ContentLength = c.Length, Parent = r);

return r;

}
//
// This implementation of the flat scheme uses fixed-size blocks.
// However, any splitting method based on deterministic-sized blocks
// will do, e.g. blocks end at the end of the first word on
// which the block exceeds some predetermined size, or at the end
// of the content.
//
CollageFlatScheme GenerateFlatScheme(Content c){

if(c is not preprocessed)

c = PreprocessContent(c, false);

CollageFlatScheme r;
for(int i = 0; i < c.Length; i += FlatSchemeBlockSize){

Content contentBlock = c.GetSubContentByIndexAndLength(

index = i, maxlength = FlatSchemeBlockSize);

r.BlockElements.Add(new CollageElement(

ContentSummary = FlatSchemeSummary(contentBlock),
ContentLength = c.Length, Parent = r));

}
return r;

}
Content[ ] GetTopLevelStructureContentSections(Content c){

Based on the formatting language, split c into content sections based
on the document structure. This method only splits the content based
on the top-level structure of the document (i.e. it does not recurse
into the top-level sections) The content sections:

* Should not overlap
* Should provide complete coverage of c

return array of content sections

}
// Structural/Hierarchical Scheme
CollageSHScheme GenerateSHScheme(Content c, int level){

if(c is not preprocessed)

c = PreprocessContent(c, true);

CollageSHScheme r;
Content[ ] structureContentSections =

GetTopLevelStructureContentSections(c);

foreach(Content s in structureContentSections){

ContentCollage sectionCollage =

GenerateContentCollage(s, level + 1);

sectionCollage.Parent = r;
r.SectionCollages.Add(sectionCollage);

}
return r;

}
// ------------- Collage Generators ------------
ContentCollage GenerateContentCollage(Content c, int level){

ContentCollage collage;
bool shouldGenerateFlatScheme = *** Determine whether to generate a

flat scheme or not, e.g. only if c.Length >
3*FlatSchemeBlockSize ***

if(shouldGenerateFlatScheme){

CollageFlatScheme scheme = GenerateFlatScheme(c);
scheme.Parent = collage;
collage.ContentSchemes.Add(scheme);

}
bool shouldGenerateSHScheme = *** Determine whether to generate an

SH scheme or not, e.g. only if level < MaxSHLevel and
c.Length > some threshold ***

if(shouldGenerateSHScheme &&

GetTopLevelStructureContentSections(c).Length > 1)

{

CollageSHScheme scheme = GenerateSHScheme(c, level);
scheme.Parent = collage;
collage.ContentSchemes.Add(scheme);

}
bool shouldGenerateSimpleScheme = *** Determine whether to generate a

simple scheme or not, e.g. generate only when level > 0. NOTICE
THAT SIMPLE SCHEME MUST BE GENERATED IF NO OTHER SCHEME WAS
GENERATED! ! ! ***

if(shouldGenerateSimpleScheme){

CollageSimpleScheme scheme = GenerateSimpleScheme(c);
scheme.Parent = collage;
collage.ContentSchemes.Add(scheme);

}
return collage;

}
DocumentCollage GenerateDocumentCollage(Document d){

DocumentCollage docCollage;
docCollage.DocumentDate = d.Attributes.DocumentDate;
docCollage.DocumentAddress = d.Attributes.DocumentAddress;

// e.g. the document's URL

docCollage.Collage = GenerateDocumentCollage(d.DocumentContent, 0);
docCollage.Collage.Parent = docCollage;

}
// ------------- Document indexing -----------------
DocumentCollage GetLatestIndexedCollageByAddress(Address DocAddress){

DocumentCollage[ ] matchingCollages = retrieve all DocumentCollages

with docCollage.DocumentAddress == DocAddress,
sorted by DocumentDate in descending order;

// this is an index-based operation
// as both properties are indexed

return matchingCollages.Length == 0 ? null : matchingCollages[0];

}
PUBLIC void IndexDocument(Document d){

DocumentCollage docCollage = GenerateDocumentCollage(d);
DocumentCollage latestIndexedCollage =

GetLatestIndexedCollageByAddress(d.Attributes.DocumentAddress);

//
// this pseudo-code cares only for modification dates, so a new
// DocumentCollage is stored only when changes are detected or when no
// document previously existed at the address.
//
// Other date considerations (e.g. care about search engine visit
// dates) may result in different implementations.
//
if(latestIndexedCollage == null OR not

EqualCollages(docCollage.Collage,
latestIndexedCollage.Collage))

{

Store docCollage in the database and (recursively) index using
all [indexed] properties of the docCollage and its descendant
objects;

}

}
// ------------- utility methods --------------------
CollageScheme GetParentCollageScheme(CollageObject o){

CollageObject p;
p = o.Parent;
while(p != null AND (p is not CollageScheme))

p = p.Parent;

| | |
|---|---|
| return p; | // return either null or a CollageScheme |

}
DocumentCollage GetParentDocumentCollage(CollageObject o){

CollageObject p;
p = o.Parent;
while(p != null AND (p is not DocumentCollage))

p = p.Parent;

| | |
|---|---|
| return p; | // return either null or a CollageScheme |

}
// ------------- search utility methods ---------------------
CollageElement[ ] GetIndexedCollageElementsByContentSummaryAndLength(

ContentSummaryValue cs, int Length)

{

return all CollageElements in the database whose ContentSummary == cs
AND ContentLength == Length, or an empty set if none (index
operation);

}
CollageElement[ ] GetSimpleSchemeMatchingCollageElements(Content c){

if(c is not preprocessed)

c = PreprocessContent(c, false);

CollageElement[ ] matchingElements =

GetIndexedCollageElementsByContentSummaryAndLength(
SimpleSchemeSummary(c), c.Length);

foreach(CollageElement e in matchingElements){

if(GetParentCollageScheme(e) is not CollageSimpleScheme)

remove e from matchingElements;

}
return matchingElements;

}
CollageElement[ ] GetSlidingWindowMatchingCollageElements(Content c){

CollageElement[ ] r;
if(c is not preprocessed)

c = PreprocessContent(c, false);

ContentSummaryValue flatSchemeCS = null;
for(int i = 0; i < c.Length; i++){

// the following line may be implemented in 0(1) for i > 0 by
// taking advantage of the sliding window movement
Content contentBlock = c.GetSubContentByIndexAndLength(

index = i, maxLength = FlatSchemeBlockSize);

if(flatSchemeCS == null OR flatSchemeCS not updatable)

flatSchemeCS = FlatSchemeSummary(contentBlock);

else{

//
// the updated flatSchemeCS must be equal to
// FlatSchemeSummary(contentBlock)
//
update flatSchemeCS to reflect the sliding
window movement;

}
CollageElement[ ] matchingElements =

GetIndexedCollageElementsByContentSummaryAndLength(
flatSchemeCS, contentBlock.Length);

foreach(CollageElement e in matchingElements){

if(GetParentCollageScheme(e) is not CollageFlatScheme)

remove e from matchingElements;

}
r.Add(matchingElements);

}
return r;

}
CollageElement[ ] GetSHMatchingCollageElements(Content c){

CollageElement[ ] r;
if(c is not preprocessed)

c = PreprocessContent(c, true);

Content[ ] structureContentSections =

GetTopLevelStructureContentSections(c);

if(structureContentSections.Length <= 1)

| | |
|---|---|
| return r; | // empty set |

foreach(Content s in structureContentSections){

| r.Add(GetSimpleSchemeMatchingCollageElements(s)); | |
|---|---|
| r.Add(GetSlidingWindowMatchingCollageElements(s)); | |
| r.Add(GetSHMatchingCollageElements(s)); | // recursive step |

}
return r;

}
// -------------- Match Coverage functions --------------------
struct MatchCoverageInfo {

| | |
|---|---|
| int | MatchLength; |
| int | SpannedContentLength; |

}
MatchCoverageInfo GetMatchCoverageInfo(CollageObject Root,

CollageElement[ ] MatchingElements, MatchCoverageCache Cache)

{

if(Cache.Contains(Root))

return Cache[Root];

MatchCoverageInfo r;
if (Root is DocumentCollage)

r = GetMatchCoverageInfo(Root.Collage, MatchingElements, Cache);

// match coverage is that of the document's
// content collage's

else if(Root is ContentCollage){

MatchCoverageInfo maxMatchCoverage =

new MatchCoverageInfo(MatchLength = 0,
SpannedContentLength = 0);

foreach(CollageScheme scheme in Root.ContentSchemes){

MatchCoverageInfo schemeMatchCoverage =

GetMatchCoverageInfo(scheme, MatchingElements,
Cache);

if(schemeMatchCoverage.MatchLength >

maxMatchCoverage.MatchLength)

// notice that SpannedContentLength is
// the same for all schemes

{

maxMatchCoverage = schemeMatchCoverage;

}

}
r = maxMatchCoverage;

}
else if(Root is CollageSimpleScheme){

r = GetMatchCoverageInfo(Root.Element, MatchingElements, Cache);

}
else if(Root is CollageFlatScheme){

int totalMatchLength = 0;
int totalSpannedContentLength = 0;
foreach(CollageElement e in Root.BlockElements){

MatchCoverageInfo elementCoverage =

GetMatchCoverageInfo(e, MatchingElements, Cache);

totalMatchLength += elementCoverage.MatchLength;
totalSpannedContentLength +=

elementCoverage.SpannedContentLength;

}
r = new MatchCoverageInfo(MatchLength = totalMatchLength,

SpannedContentLength = totalSpannedContentLength);

}
else if(Root is CollageSHScheme){

int totalMatchLength = 0;
int totalSpannedContentLength = 0;
foreach(ContentCollage section in Root.SectionCollages){

MatchCoverageInfo sectionCoverage =

GetMatchCoverageInfo(section, MatchingElements,
Cache);

totalMatchLength += sectionCoverage.MatchLength;
totalSpannedContentLength +=

sectionCoverage.SpannedContentLength;

}
r = new MatchCoverageInfo(MatchLength = totalMatchLength,

SpannedContentLength = totalSpannedContentLength);

}
else if(Root is CollageElement){

r = new MatchCoverageInfo(

MatchLength = (Root in MatchingElements) ?
Root.ContentLength : 0,
SpannedContentLength = Root.ContentLength);

}
Cache[Root] = r;
return r;

}
float GetMatchCoverage(int SearchedContentLength, CollageObject Root,

CollageElement[ ] MatchingElements, MatchCoverageCache Cache)

{

MatchCoverageInfo mci = GetMatchCoverageInfo(Root, MatchingElements,

Cache);

//
// The Match Coverage is the degree of similarity between the
// searched content and the spanned content. So we have two groups:
// the searched content and the spanned content. GetMatchCoverageInfo
// returns the size of the spanned content and the size of subgroup of
// the spanned content which matches the searched content. The
// similarity is the size of the matching group. The dissimilarity is
// the sum of the subgroups which don't match, both in the searched
// content and in the spanned content. Their sizes are
// (SearchedContentLength − mci.MatchLength) and
// (mci.SpannedContentLength − mci.MatchLength), respectively. So the
// union of the similarity group and the dissimilarity groups is of
// the size: mci.MatchLength + (SearchedContentLength −
// mci.MatchLength) + (mci.SpannedContentLength − mci.MatchLength),
// which is (SearchedContentLength + mci.SpannedContentLength −
// mci.MatchLength).
//
// The Match Coverage is therefore the size of the similarity group
// divided by the size of the union.
//
return mci.MatchLength / (SearchedContentLength +

mci.SpannedContentLength − mci.MatchLength);

}
float GetMaxParentMatchCoverage(int SearchedContentLength,

CollageObject StartObject, CollageElement[ ] MatchingElements,
MatchCoverageCache Cache)

}

float maxMatchCoverage = 0;
CollageObject obj = StartObject;
while(obj != null){

float matchCoverage = GetMatchCoverage(SearchedContentLength,

obj, MatchingElements, Cache);

if(matchCoverage > maxMatchCoverage)

maxMatchCoverage = matchCoverage;

obj = obj.Parent;

}
return maxMatchCoverage;

}
// -------------- search functions ----------------------------
PUBLIC Date GetOriginalDocumentDate(Document d){

return GetOriginalDate(d.DocumentContent);

}
PUBLIC DocumentAttributes GetOriginalDate(Content c,

float SimilarityThreshold)

{

DocumentAttributes earliestDocumentAttributes = null;
CollageElement[ ] matchingElements;
matchingElements.Add(GetSimpleSchemeMatchingCollageElements(c));
matchingElements.Add(GetSlidingWindowMatchingCollageElements(c));
matchingElements.Add(GetSHMatchingCollageElements(c));
MatchCoverageCache cache;
foreach(CollageElement e in matchingElements){

float maxParentMatchCoverage =

GetMaxParentMatchCoverage(c.Length, e,
matchingElements, cache);

if(maxParentMatchCoverage >= SimilarityThreshold){

DocumentCollage parentDocumentCollage =

GetParentDocumentCollage(e);

if(earliestDocumentAttributes == null ||

parentDocumentCollage.DocumentDate <
earliestDocumentAttributes.DocumentDate)

{

earliestDocumentAttributes =

new DocumentAttributes(DocumentDate =
parentDocumentCollage.DocumentDate,
DocumentAddress =
parentDocumentCollage.DocumentAddress);

}

}

}
return earliestDocumentAttributes;

}
PUBLIC DocumentAttributes[ ] TrackContent(Content c,

float SimilarityThreshold)

{

DocumentAttributes[ ] r;
CollageElement[ ] matchingElements;
matchingElements.Add(GetSimpleSchemeMatchingCollageElements(c));
matchingElements.Add(GetSlidingWindowMatchingCollageElements(c));
matchingElements.Add(GetSHMatchingCollageElements(c));
MatchCoverageCache cache;
foreach(CollageElement e in matchingElements){

float maxParentMatchCoverage =

GetMaxParentMatchCoverage(c.Length, e, matchingElements,
cache);

if(maxParentMatchCoverage >= SimilarityThreshold){

DocumentCollage parentDocumentCollage =

GetParentDocumentCollage(e);

r.Add(new DocumentAttributes(DocumentDate =

parentDocumentCollage.DocumentDate,
DocumentAddress =
parentDocumentCollage.DocumentAddress))

}

}
Sort r by (DocumentAddress, DocumentDate)
Remove duplicate (DocumentAddress, DocumentDate) pairs from r
return r;

}
PUBLIC Content[ ] FilterContentByOriginalDate(Content[ ] ContentToFilter,
float SimilarityThreshold,

Date MinDate, Date MaxDate)

{

Content[ ] r;
foreach(Content c in ContentToFilter){

DocumentAttributes attr =

GetOriginalDate(c, SimilarityThreshold);

if(attr != null AND MinDate <= attr.DocumentDate AND

attr.DocumentDate <= MaxDate)

{

r.Add(c);

}

}
return r;

}

What is claimed is:

1. A method implemented in a computer system for determining a date for a particular document, the method comprising:
maintaining in the computer system information associated with a plurality of documents, each document being associated with a respective date;
determining in the computer system based on the information matching one or more of the plurality of documents, base on a similarity threshold; and
attributing in the computer system a date to the particular document based on a date associated with at least one of the matching documents.
